(19) United States
(12) Patent Application Publication
(10) Pub. No.: US 2004/0034999 A1
(43) Pub. Date: Feb. 26, 2004

(54) Method of repairing a damaged or deformed wheel

(75) Inventor: Danny O?apos;Neil Blaser JR., Southlake, TX (US)

Correspondence Address: Michael L. Diaz, Michael L. Diaz, P.C., Suite 200, 555 Republic Drive, Plano, TX, 75074, US

(73) Assignee: WHEELS TECHNOLOGY, INC.

(21) Appl. No.: 10/228,237

(22) Filed: Aug. 26, 2002

(51) Int. Cl. B23P 6/00; B29C 73/00

(52) U.S. Cl. 29/894.3; 29/402.01

(57) ABSTRACT

A method of refurbishing a wheel is disclosed. The method provides a standardized efficient and effective way of repairing a damaged or deformed wheel. The method includes cleaning the wheel, inspecting the wheel for damage, welding damaged areas of the wheel, straightening the wheel, machining the beat seat of the wheel, determining a finish to apply to the wheel surface, and applying a finish to the wheel.

### BACKGROUND OF THE INVENTION

1. Technical Field of the Invention

This invention relates to vehicular repairs, and more particularly, to a method of repairing damaged or deformed wheels of a vehicle.

2. Description of Related Art

Conventional vehicles normally utilize wheels constructed of a metallic alloy having a tire mounted about each wheel of the vehicle. In recent years, the wheels are constructed of very lightweight materials such as aluminum or magnesium. There are various advantages to utilizing such materials, such as reduction of weight, improved fuel efficiency, and enhanced aesthetics of the vehicle. However, the material, although relatively strong for its weight, is susceptible to damage during accidents. In the past, when the wheel has been damaged or deformed, the wheel would be discarded. However, recently, technology has improved within the vehicle repair industry in such a fashion that the wheel, in many cases, may now be repaired.

There have been various methods developed in recent years to refurbish damaged or deformed wheels. For example, many repair centers now utilize spot heat treatments, such as from a torch on a specific area. The heat treatments are followed by applying force to reshape the damaged wheel to its original form. In addition, repair centers utilize a hammer or “dog bone” tool to straighten damaged wheels.

The existing methods used to refurbish wheels have several disadvantages. The existing methods do not efficiently or effectively repair the damaged wheels in a cost-effective and timely manner. The methods employed by existing wheel refurbishment shops are also haphazard and inconsistent. Typically, repair of a wheel is left completely to the discretion of each refurbishment technician. Since skills and observation skills vary from person to person, so does the refurbishment process accomplished by each technician. A method is needed which provides a standardized, cost effective, safe, and timely manner of repairing damaged or deformed wheels.

Review of existing methodologies reveals no disclosure or suggestion of a method as that described and claimed herein. Thus, it would be a distinct advantage to have a method which efficiently and effectively repairs damaged wheels in a standardized manner. It is an object of the present invention to provide such a methodology.

### SUMMARY OF THE INVENTION

In one aspect, the present invention is a method of refurbishing a wheel. The method begins by a technician cleaning the wheel for revealing damage. The wheel is then examined and a determination is made by the technician if the wheel is repairable. If the wheel is repairable, the wheel is welded in the damaged areas of the wheel. Next, the wheel is straightened by a wheel straightening mechanism. A run out is determined by the technician. Next, a type of finish to apply to the wheel is determined. The determined type of finish is then applied to the wheel. The type of finish may include painting, polishing, machining, and chrome plating the surface of the wheel.

### BRIEF DESCRIPTION OF THE DRAWINGS

The invention will be better understood and its numerous objects and advantages will become more apparent to those skilled in tile art by reference to the following drawings, in conjunction with the accompanying specification, in which:

FIG. 1 is a simplified block diagram illustrating the components of a refurbishing system in the preferred embodiment of the present invention; and

FIGS. 2A-F are flow charts outlining the steps for refurbishing a damaged or deformed wheel according to the teachings of the present invention.

### DETAILED DESCRIPTION OF EMBODIMENTS

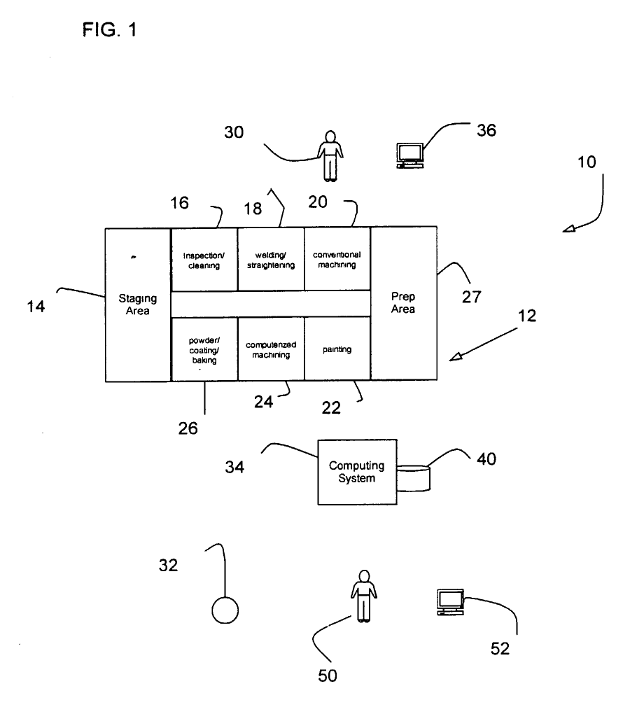

A method of efficiently and effectively refurbishing a damaged or deformed wheel in a standardized manner is disclosed. FIG. 1 is a simplified block diagram illustrating the components of a refurbishing system 10 in the preferred embodiment of the present invention. The system 10 includes a repair center 12 having a staging area 14, an inspection/cleaning area 16, a welding/straightening area 18, a conventional machining area 20, a painting area 22, a computerized machining area 24, a powder/coating/baking area 26, and a preparation area (sanding and polishing) 27. In addition, a technician 30 repairs a wheel 32. The technician and any employee of the repair center may communicate with a computing system 34 through an employee computer terminal 36. The computing system stores information within a database 40. A customer 50 may communicate with the computing system through a customer terminal 52 having a communication link with the computing system.

It should be understood to one skill in the art of wheel refurbishment that the components or departments of the repair center may vary in the naming and configuration and still be utilized with the present invention. In the preferred embodiment of the present invention, all the departments are located in one location for ease of processing the wheel 32. However, in an alternate embodiment of the present invention, some or all the departments may be located away from the repair center.

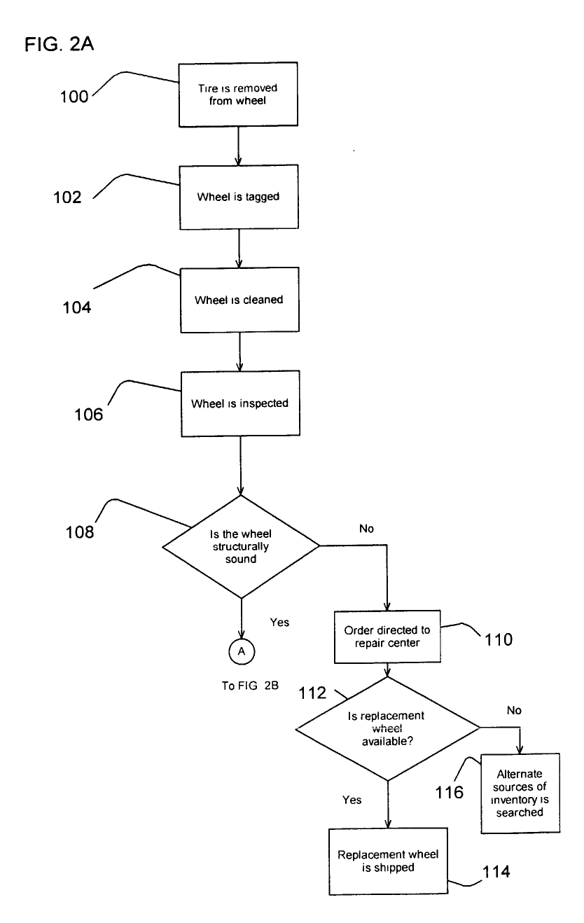

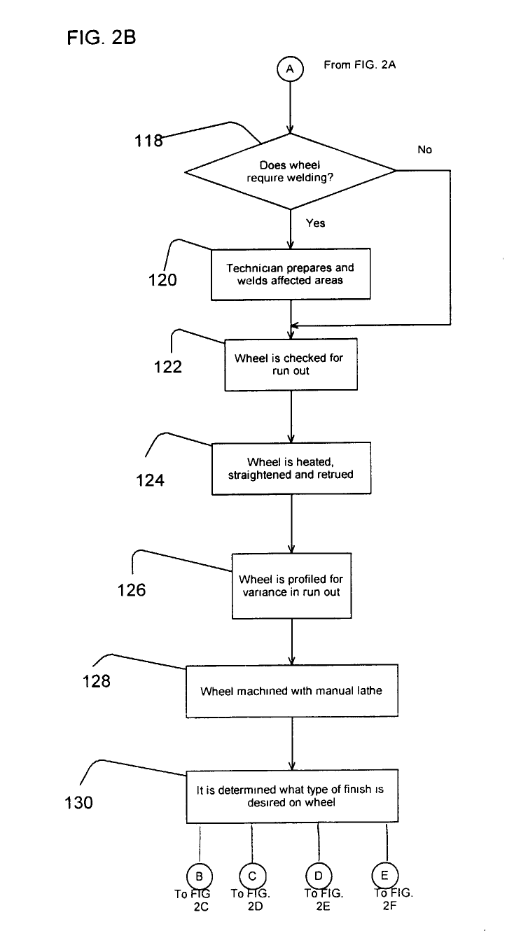

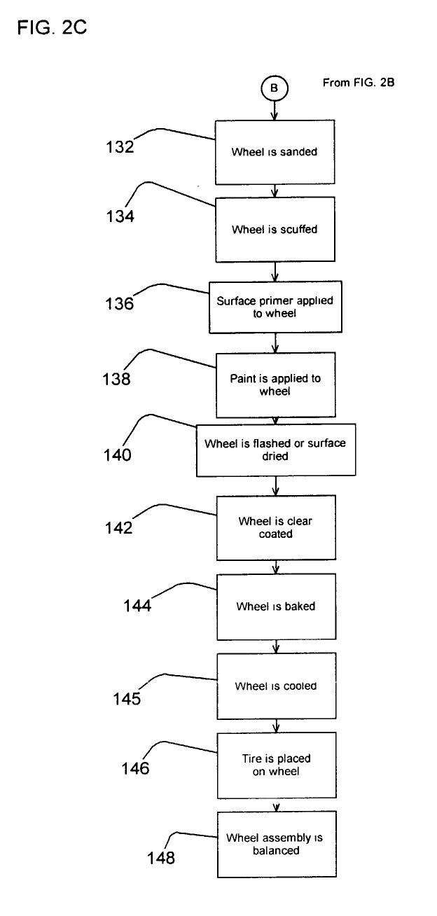

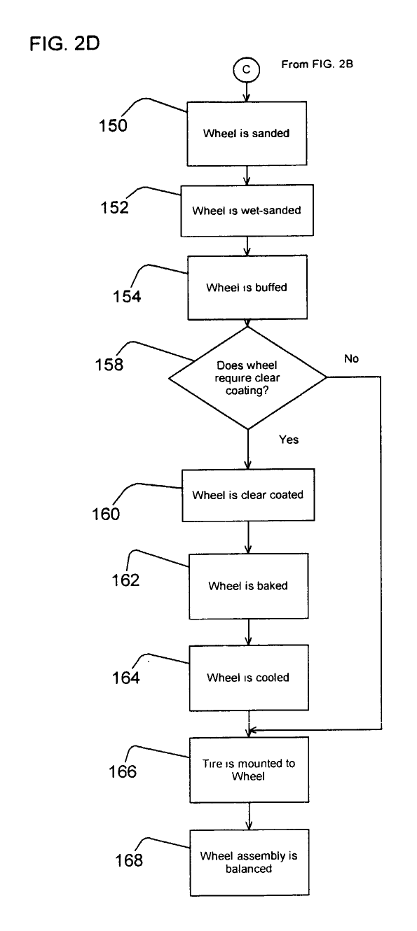

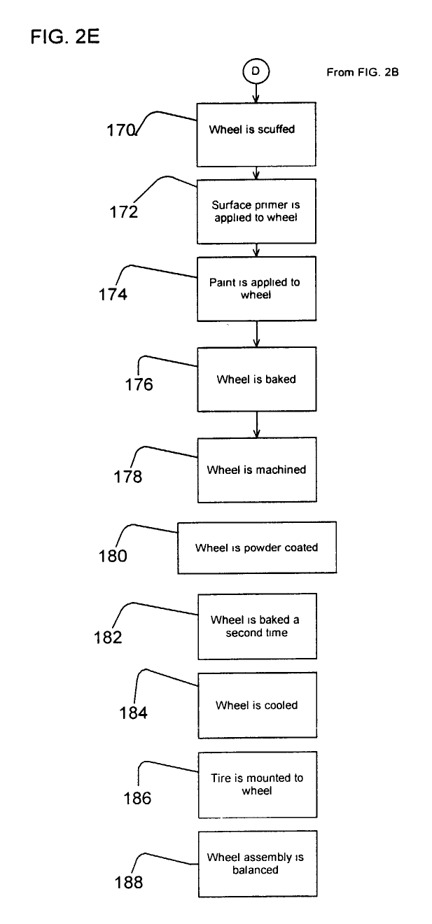

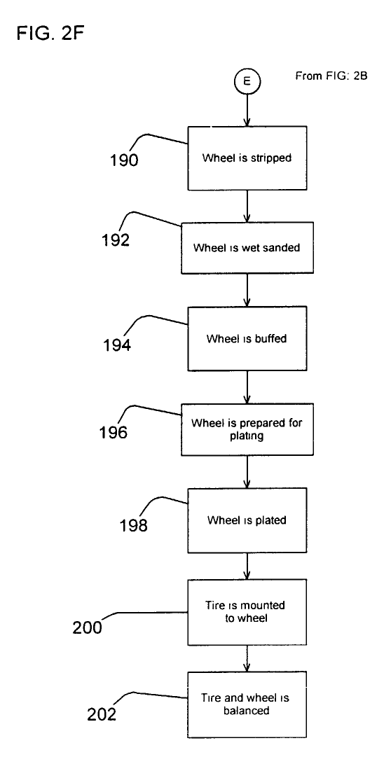

FIGS. 2A-F are flow charts outlining the steps for refurbishing a damaged or deformed wheel according to the teachings of the present invention. Referring to FIGS. 1 and 2A-F, the method will now be explained. The method begins with step 100 where a technician 30 removes a tire from a damaged wheel 32. Next, in step 102, the technician places an identifying mark on the damaged wheel 32. Preferably, the wheel is identified by affixing a tag with customer information on the wheel (e.g., wheel identification number, work order number, paint code, tire information, serial number, internal tracking number, etc.). In the preferred embodiment of the present invention, an internal tracking number is issued and affixed as a tag to the wheel to identify the wheel. Alternatively, the tracking number may also be written on the barrel of the wheel using a permanent marker. This number may also be inputted into a computing system for storage within a database (not shown). The internal tracking number may be associated with a specific customer 50, as well as additional relevant data. Throughout the process, the technician may periodically input progress reports of the specified wheel into the computing system 34, where the progress reports may be stored within the database 40 through the employee computer terminal 36. The customer may optionally access the database to track the progress of the wheel. In addition, other types of information may be stored for the customer within the database, such as account information, order status, and payment information. This information may be available to the customer via a communication link between the customer terminal 52 and the database 40, such as through the Internet.

Next, in step 104, the wheel 32 is cleaned, prior to inspection. The wheel is throughly cleaned, thus allowing the technician 30 to carefully inspect damage inflicted upon the wheel. The wheel may be washed in an acid cleaning solution. The wheel is pre-soaked in this solution to loosen and remove all foreign matter, such as disc brake dust, grease, brake fluid, and road film. After soaking, the wheel is scrubbed using a stiff nylon scrub brush or an abrasive hand pad. The wheel is then rinsed using fresh, clean water. The wheel may then be dried utilizing compressed air. Next, in step 106, the technician inspects the wheel for damage and basic structural integrity of the wheel.

In step 108, it is determined by the technician if the wheel is structurally sound and a candidate for the refurbishment process. Specifically, the wheel is inspected for lateral run out and concentricity using a measuring indicator. If lateral run out is found, the hub and spoke area of the wheel is inspected for stress cracks. Stress cracks indicate that the structural integrity of the wheel is compromised and should not be repaired. Several different types of conditions may render a wheel non-repairable. For example, bent spokes, stress cracks at the spoke/hub area, excessive stress cracks at the damaged area, and broken areas that extend into the bead seat area at the outer circumference of the wheel all are conditions rendering a wheel non-repairable. In addition, excessive bend in the bead seat area, excessive lateral run out, excessive amounts of the rim lip missing and damaged lug holes are also conditions which typically render a wheel non-repairable.

If it is determined that the wheel is not structurally sound, the method moves from step 108 to step 110, where the customer's order is directed to an administration section of the repair center 12. Next, in step 112, the repair center accesses the database 40 to determine if the same type of wheel is located within the repair center 12's inventory. If it is determined that the same type of wheel is available, the method moves to step 114, where the repair center initiates the shipping process. The shipping process may include querying the customer to determine if the customer desires a replacement wheel. The shipping process may also include selling the wheel and shipping it to the customer. However, if it is determined that the same type of wheel is unavailable, the method moves from step 112 to step 116 where the repair center searches alternative inventory sources for a replacement wheel. The alternate inventory sources may include salvage yards, wheel manufacturers, etc.

However, if it is determined in step 108 that the wheel is structurally sound, the method then moves to step 118 where it is determined by the technician 30 whether the wheel is cracked, gouged, or requires welding. In step 120, the technician prepares and welds the affected areas. The technician, within the welding/straightening area 18, searches for any broken areas, cracks, nicks, gouges or scrapes and repairs the damage through welding. Prior to welding, the technician prepares the area for welding. All paint is removed surrounding the affected area. Any broken area is ground to remove jagged areas left by a fracture. For crack damage, the entire crack is preferably ground away. Any edges requiring welding are normally beveled to a minimum of half the thickness of the material. All grinding dust and aluminum dust are then removed by compressed air. The welding process preferably utilizes pure grade aluminum. Any excess welds are preferably ground away to expedite the machining of the bead seat area, outer diameter of the wheel, and the face of the lip on the bead seat lathe. The welding process provides for a stronger wheel than when originally manufactured.

Next, in step 122, the wheel 32 is checked with a measuring device, such as a dial indicator used for measuring run out of the wheel trueness. Next, in step 124, the wheel is heated, straightened and re-trued. This straightening process may include utilizing a force application device. The wheel is preferably heated at the region where the wheel requires reshaping. Also, in step 118, if it is determined that the wheel does not require welding the method moves to step 122.

The method then moves to step 126 where the wheel 32 is profiled for any variance in run out. This may be accomplished in a manual lathe having a special arbor and faceplate to accept the wheel in a straight and true fashion. Next, in step 128, the manual lathe within the conventional machining area 20 removes only that amount of metal necessary to achieve a smooth area on the circumference of the bead seat areas. In addition, the outside diameter at the front and rear wheel lips are also machined for cosmetic reasons, thus achieving a “true” appearance for the wheel. Up to several thousandths of an inch of material from the face of the wheel may be removed to eliminate any minor scratches and any excess material left during the welding process of step 120.

The method then moves to step 130 where it is determined the type of final finish desired for the wheel 32. Preferably, the wheel is finished with the original type of finish prior to being damaged. The finish of the wheel may be painted, polished, machined or chrome plated. One or more of these finishes may be utilized on the wheel 32. Also, it should be understood that any finish may be utilized by the present invention.

If it is determined that the wheel requires painting, the method moves from step 130 to step 132 (FIG. 2C) where the wheel is sanded and imperfections are filled. Preparation of the wheel is critical to insure that the finish of the wheel is adequate. An abrasive, preferably 80 to 1000 grit abrasive, is used with a compressed air power device to ground flush the welded areas. In addition, the surrounding areas are ground, with special emphasis being placed on both flat and contoured surfaces. All welds are ground and sanded, to include the inside and outside diameters of the wheel barrel. Using progressively finer grit abrasives, the entire face of the wheel is sanded. Sanding is required until the flaws in the surface contour of the wheel are flush and level with the surrounding contour. The wheel is then wiped down with a wax and grease remover and inspected for any flaws in the surface. Any flaws found at this point must then be addressed. Some areas of the wheel may need to be masked from paint. A fine line masking tape may be used to produce a crisp, clean edge when painted and removed before the wheel has completely cured. Generic masking tape may be used to protect the area inside the fine line tape, where paint is not to be applied. This preparation step is accomplished within the painting area 22.

Next, in step 134, the surface of the wheel 32 is scuffed in preparation for a primer application. In step 136, a surface primer is applied. Once applied, the curing process normally starts immediately. A finish color is determined for the wheel. The proper tint/color of the wheel must be determined so that the wheel matches any other wheels attached to the same vehicle. Once the finish color is determined, the paint is mixed to achieve the desired color. Next, in step 138, the paint is then applied to the wheel. The paint may include metal flakes providing for enhancing the appearance of the wheel. Preferably, a second or multiple layers of paint may be optionally applied to the wheel.

The method then moves to step 140 where the wheel is “flashed or surface” dried. In this process, the wheel's outer surface is allowed to harden. However, the following steps may be accomplished prior to the complete curing of the paint layer applied to the wheel. Next, in step 142, the wheel 32 is clear coated in the painting area 22. To clear coat the wheel, the wheel is cleaned in a totally dust free environment. A special material is utilized that is especially made for aluminum. This clear coating etches into the surface of the wheel and provides a crystal clear finish which is bonded to the aluminum. A second coating may be added. In step 144, the wheel is baked within a baking oven in the powder/coating/baking area 26. The wheel is baked. In step 145, the wheel is then removed from the oven and gradually cooled on a special cooling rack at room temperature which allows the wheel to completely cool. Next, in step 146, a tire is placed on the wheel. In step 148, the entire wheel assembly (wheel and tire) is balanced, thus providing a fully refurbished wheel.

However, in step 130 if it is determined that the wheel requires polishing, the method moves from step 130 to step 150 (FIG. 2D) where the wheel is sanded. An abrasive, preferably 80 to 1000 grit abrasive, is used with a compressed air power device to ground flush the welded areas. In addition, the surrounding areas are ground, with special emphasis being placed on both flat and contoured surfaces. All welds are ground and sanded, to include the inside and outside diameters of the wheel barrel. Using progressively finer grit abrasives, the entire face of the wheel is sanded. Sanding is required until the flaws in the surface contour of the wheel are flush and level with the surrounding contour. Next, in step 152, the wheel is wet-sanded. The scratches and blemishes are removed using an ultra fine “wet” sanding paper which is rubbed on the wheel. The sanding paper may be applied manually by the technician 30 or by a sanding machine. In step 154, the wheel is buffed. The wheel is preferably buffed to a shine utilizing a special polishing “rouge.” Next, in step 156, the wheel is polished. Polishing is the process that changes the surface of metal or plastics from a dull, scratched appearance to a mirror-like finish. Polishing is accomplishing by utilizing several different grades of sandpaper. Each application of sandpaper is incrementally finer than the previous application. During preparation, any gouges in the surface of the wheel are filled with weld and sanded smooth. A series of polishing compounds called rouge may also be applied to the wheel. A polish having some abrasive qualities is then applied. Preferably, a polishing wheel is utilized to provide a relatively large amount of pressure to the surface during the polish application.

The method then moves to step 158 where it is determined if the wheel requires clear coating. If it is determined that the wheel requires clear coating, the method moves from step 158 to step 160 where the wheel 32 is clear coated in the painting area 22. To clear coat the wheel, the wheel is cleaned in a totally dust free environment. A special material is utilized that is especially made for aluminum. This clear coating etches into the surface of the wheel and provides a crystal clear finish which is bonded to the aluminum. A second coating may be added. In step 162, the wheel is baked within a baking oven in the powder/coating/baking area 26. The wheel is then baked. Next, in step 164, the wheel is removed from the oven and gradually cooled on a special cooling rack at room temperature which allows the wheel to completely cool. Next, in step 166, a tire is mounted to the wheel. In step 168, the wheel assembly is balanced.

However, in step 158, if it is determined that clear coating is not required for the wheel 32, the method moves from step 158 to step 166 where a tire is mounted to the wheel. Next in step 168, the wheel assembly is balanced.

However, in step 130 if it is determined that the wheel requires machining, the method moves to step 170 (FIG. 2E) where the surface of the wheel 32 is scuffed in preparation for a primer application. In step 172, a surface primer is applied. Once applied, the curing process normally starts immediately. A finish color is determined for the wheel. The proper tint/color of the wheel must be determined so that the wheel matches any other wheels attached to the same vehicle. Once the finish color is determined, the paint is mixed to achieve the desired color. The paint mixture may include the addition of metal flakes. Next, in step 174, the paint is then applied to the wheel. Preferably, a second layer of paint is also applied to the wheel. Next, in step 176, the painted wheel is baked in the oven in the powder/coating/baking area 26.

The method then moves to step 178 where the wheel is machined by a high speed Computer Numerically Controlled (CNC) lathe. The CNC lathe may be used for rim cutting and full face contour machining of the wheel, prior to powder coating of the wheel. CNC programming and operation is well known to those skilled in the art of machining and will not be discussed. A program specific for each type of wheel is stored on a removable storage device. The wheel is gripped on the back rim lip by a self-centering three-jaw chuck. The chuck has three gripping devices (jaws) mounted on the face of the chuck, which ride on a flat spiral inside the chuck. Turning one jaw adjusting screw on an outer diameter of the chuck causes all the jaws to move simultaneously and exactly the same amount, which causes the jaws to move in toward the center or out toward the outer diameter of the chuck. The jaws thus maintain a position concentric to the centerline of the lathe, without being dependent of the wheel's diameter. The jaws are designed to clamp the wheel in a position perpendicular to the centerline of the lathe and concentric to the centerline of the lathe with no other adjustments required.

Next, the wheel 32 is powder coated in step 180. First, the wheel is cleaned by various methods, such as sandblasting or using phosphates. The powder coating is a dry finishing process, utilizing finely ground particles of pigment and resin which are electrostatically charged to over 90,000 volts and sprayed onto the part to be coated. The wheel itself is grounded so that the charged powder particles are projected at the wheel and, thus, adhere to the wheel. This powder coating step is also accomplished with the powder/coating/baking area 26. Next, in step 182, the wheel is baked a second time. In this baking session, the temperature is approximately 400 degrees Fahrenheit. In step 184, the wheel is then cooled on a cooling rack at room temperature. After cooling, a tire is mounted to the wheel in step 186. In step 188, the wheel assembly is balanced.

However, in step 130 if it is determined that the wheel requires chrome plating, the method moves to step 190 (FIG. 2F) where the wheel is stripped of chrome plating as required for repair of the wheel. Next, in step 192, the wheel is wet-sanded. The scratches and blemishes are removed using an ultra fine “wet” sanding paper which is rubbed on the wheel. The sanding paper may be applied manually by the technician 30 or by a sanding machine. In step 194, the wheel is buffed.

In step 196, the wheel 32 is prepared for chrome plating. Preparation includes paint stripping and chemically preparing the wheel for plating. A layer of copper is then added. In addition, another polishing process may be used to provide a high luster and smooth finish to the wheel. The method then moves to step 198 where the wheel is plated with layers of nickel and chromium through an electrolytic process utilizing chromic acid. The wheel to be plated acts as a cathode as DC current is applied via lead anodes. Chromium metal then collects on the surface. The wheel is thus layered with a durable, corrosion-resistant layer. In step 200, after plating of the wheel, a tire is mounted to the wheel. In step 202, the tire and wheel are balanced.

The methodology may include one or more types of finishes determined in step 130. For example, the wheel may be applied with a painted and also machined. The methodology discussed in FIGS. 1 and 2A-D provide many advantages over existing methodologies in refurbishing damaged or deformed wheels. The present invention provides a standardized method of refurbishing the wheels in an efficient and effective manner. By following a standardized methodology, all the wheels are refurbished to their highest quality. In addition, the entire process may be completed within a 24-hour period.

It is thus believed that the operation and construction of the present invention will be apparent from the foregoing description. While the method shown and described has been characterized as being preferred, it will be readily apparent that various changes and modifications could be made therein without departing from the scope of the invention as defined in the following claims.

What is claimed is:

1. A method of refurbishing a wheel, said method comprising the steps of:
cleaning the wheel for revealing damage to a technician refurbishing the wheel;
inspecting the wheel by the technician;
determining, by the technician, if the wheel is repairable;
if the wheel is repairable, straightening the wheel utilizing a force application mechanism;
determining run out of the wheel by the technician;
determining a type of finish to apply to the wheel; and
upon determining a type of finish to apply to the wheel, applying a specific finish to the wheel.

2. The method of refurbishing a wheel of claim 1 wherein the step of applying a specific finish to the wheel includes painting a surface of the wheel.

3. The method of refurbishing a wheel of claim 2 wherein the step of painting a surface of a wheel includes:
sanding the surface of the wheel;
applying a surface primer to the surface of the wheel; and
applying a paint coating to the surface of the wheel.

4. The method of refurbishing a wheel of claim 3 wherein the step of painting a surface of the wheel includes:
after applying a paint coating to the surface of the wheel, applying a clear coating to the surface of the wheel; and
baking the wheel in an oven.

5. The method of refurbishing a wheel of claim 1 wherein the step of applying a specific finish to the wheel includes polishing a surface of the wheel.

6. The method of refurbishing a wheel of claim 5 wherein the step of polishing a surface of the wheel includes:
sanding the surface of the wheel;
buffing the surface of the wheel; and
polishing the surface of the wheel.

7. The method of refurbishing a wheel of claim 6 wherein the step of polishing a surface of the wheel includes:
after the step of polishing the surface of the wheel, applying a clear coating to the surface of the wheel; and
baking the wheel in an oven.

8. The method of refurbishing a wheel of claim 1 wherein the step of applying a specific finish to the wheel includes machining the wheel.

9. The method of refurbishing a wheel of claim 8 wherein the step of machining a wheel includes:
applying a surface primer to the surface of the wheel;
applying paint to the surface of the wheel;
baking the wheel in an oven;
machining the wheel with a computer-operated lathe;
powder coating the surface of the wheel; and
baking a second time the wheel in the oven.

10. The method of refurbishing a wheel of claim 9 wherein the computer-operated lathe is a Computer Numerically Controlled (CNC) lathe for machining the wheel to original wheel specifications.

11. The method of refurbishing a wheel of claim 1 wherein the step of applying a specific finish to the wheel includes chrome plating a surface of the wheel.

12. The method of refurbishing a wheel of claim 11 wherein the step of chrome plating a surface of the wheel includes:
stripping a residual chrome plating from the surface of the wheel where repairs are made;
sanding the surface of the wheel;
buffing the surface of the wheel; and
chrome plating the surface of the wheel.

13. The method of refurbishing a wheel of claim 1 further comprising, after the step of determining run out of the wheel by the technician, the step of machining the wheel for achieving a smooth area on a circumference of a bead seat area of the wheel.

14. The method of refurbishing a wheel of claim 1 further comprising, after the step of straightening the wheel utilizing a force application mechanism, the step of welding the wheel to repair damage to the wheel.

15. A method of refurbishing a wheel, said method comprising the steps of:
cleaning the wheel for revealing damage to a technician refurbishing the wheel;
inspecting the wheel by the technician;
determining, by the technician, if the wheel is repairable;
if the wheel is repairable, welding any damaged surfaces;
straightening the wheel utilizing a force application mechanism;
determining run out of the wheel by the technician;
determining a type of finish to apply to the wheel; and
upon determining a type of finish to apply to the wheel, applying a specific finish to the wheel, the step of applying a specific finish to the wheel, the steps of:
if the wheel required painting, applying paint to a surface of the wheel;
if the wheel requires polishing, polishing the surface of the wheel;
if the wheel requires machining, machining the wheel; and
if the wheel requires chrome plating, chrome plating the surface of the wheel.
